(19) United States
(12) Patent Application Publication
(10) Pub. No.: US 2023/0019192 A1
(43) Pub. Date: Jan. 19, 2023

(54) TRANSPORTABLE SAMPLE DRAWING CONTAINER, SAMPLE DRAWING SYSTEM, AND METHOD FOR DRAWING A SAMPLE

(71) Applicants: Endress+Hauser (Deutschland) GmbH+Co. KG, Weil am Rhein (DE); K+S Aktiengesellschaft, Kassel (DE)

(72) Inventors: Torsten Rest, Heringen (DE); Walter Wiegand, Kirchheim (DE); Einar Möller, Ehrenkirchen (DE); Thomas Pfauch, Leipzig (DE)

(21) Appl. No.: 17/787,322

(22) PCT Filed: Dec. 9, 2020
(86) PCT No.: PCT/EP2020/085298

§ 371 Date: Jun. 19, 2022

(30) Foreign Application Priority Data
Dec. 19, 2019 (DE) 10 2019 135 275.4

(51) Int. Cl. G01N 1/20

(52) U.S. Cl. CPC G01N 1/2035; G01N 2001/1031

(57) ABSTRACT

The invention relates to a transportable sample drawing container for drawing a sample of a fluid contained in a process container, said sample drawing container being adjustable between a sample drawing position and a transport position. In the sample drawing position, at least one closable opening which is arranged at a first end section of the sample drawing container and which leads into the interior of the sample drawing container is open, and in the transport position, a sample chamber which is arranged in the interior is closed in a fluid-tight manner, wherein the sample drawing container can be inserted into a movable lock fitting. The invention additionally relates to a sample drawing system comprising the sample drawing container and a lock fitting and to a method for drawing a sample using the sample drawing system.

The invention relates to a sample drawing container of a fluid contained in a process container, a sample drawing system comprising a sample drawing container and a lock fitting, and to a method for drawing a sample.

In many areas of chemistry, biochemistry, pharmaceuticals, biotechnology, food technology, water management and environmental measurement technology, it is desirable to remove samples of a fluid from a process container once or at regular intervals, for example from a fluid-conducting pipe or a reaction vessel. The sample can subsequently be analyzed, for example, by an analysis measurement system that performs analysis methods in a partially automated or automated manner. Examples in this respect are known from DE 10 2009 029 305 A1, DE 10 2011 11 007 011 A1, DE 10 2011 075 762 A1, DE 10 2011 003 615 A1, and DE 10 2011 005 957 A1. The fluid is a flowable medium, for example an at least partially liquid and/or gaseous medium.

In the above-mentioned industries, interchangeable fittings, with which electrochemical sensors can be introduced into a process medium and removed without interrupting ongoing processes, are widely used. Electrochemical sensors detect activities of chemical substances on the basis of electrochemical measurement technology or analysis measurement technology in order to detect a correlated process variable of the process medium. Such electrochemical sensors can be designed, for example, as potentiometric sensors, such as ion-selective electrodes (ISE), especially pH electrodes, or amperometric sensors, for example disinfection sensors. Within the scope of this application, the term “electrochemical sensors” also includes sensors based on electrolyte-insulator-semiconductor (EIS) layer stacks, conductive or capacitive conductivity sensors, and (spectro)photometric sensors, for example turbidity sensors. The electrochemical sensors are axially moved, manually or automatically, between a process position and a service position of the interchangeable fitting. In the service position, the electrochemical sensor is typically sealed against the fluid. In this case, the electrochemical sensor can be removed in the service position of the interchangeable fitting and thus checked, calibrated, cleaned, and/or replaced.

It is desirable to use the above-mentioned advantage of the substantially uninterrupted and fluid-tight introduction of the electrochemical sensor for drawing a sample as well. Therefore, it is necessary to specify a sample drawing probe that can be integrated into a lock fitting, especially into an interchangeable fitting.

A sample drawing device that comprises a sampling valve serving as a lock fitting has become known from DE 10 2006 19 242 A1. The sampling valve is designed to be fixed to a standardized fermenter connector and has a sample chamber of defined volume. After closing the valve, the rear sealing element releases the path to a transport line connected thereto. One disadvantage of the solution specified in DE 10 2006 19 242 A1 is that the transport line is not completely sealed against the fluid. On the other hand, the sample chamber itself is not transportable so that the sample must be discharged from the sample chamber by means of the fluid line.

A similar solution is described in DE 10 2014 102 600 A1, which discloses a dip tube which serves as a lock fitting and with which, in a first position of the dip tube, the end of a liquid line dips into a liquid contained in a process container. For drawing a sample, the liquid can be transported from the process container into the collecting vessel by means of the presence of a pressure difference between the first end of the liquid line and a second end, leading into a collecting vessel, of the liquid line.

Therefore, the invention is based on the object of specifying a solution that can be integrated into a lock fitting in order to remove a sample from a process container sealed in a fluid-tight manner as simply as possible.

The object is achieved by a sample drawing container, a sample drawing system comprising a sample drawing container and a lock fitting, and by a method for drawing a sample.

With regard to the sample drawing container, the object is achieved by a transportable sample drawing container for drawing a sample of a fluid contained in a process container, wherein the sample drawing container is adjustable between a sample drawing position and a transport position, wherein, in the sample drawing position, at least one closable opening which is arranged on a first end section of the sample drawing container and which leads into an interior of the sample drawing container is open, wherein, in the transport position, a sample chamber which is arranged in the interior is sealed in a fluid-tight manner, and wherein the sample drawing container can be inserted into a movable lock fitting connected to the process container, in such a way that, in a first extended position of the lock fitting, the lock fitting seals the process container in a fluid-tight manner, and that, in a second retracted position of the lock fitting, the sample drawing container seals the process container in a fluid-tight manner and the sample drawing container inserted into the lock fitting projects with its first end section into the fluid.

Within the scope of the invention, at least one opening, through which the fluid can flow into the sample chamber, is provided. Of course, a plurality of such openings, which are arranged on different regions of the first end section, can also be provided. This improves the sampling, for example when the fluid is a directed flow with which the end section is subjected to different flows at different regions.

The advantages of the invention are the following:
The sampling is possible in a substantially interruption-free manner with respect to a process through which the fluid passes, since the process container is sealed in a fluid-tight manner at any time with respect to the surrounding area during the insertion and/or removal of the sample drawing container. In the extended position, the lock fitting seals the process container in a fluid-tight manner. The sample drawing container is introduced into the fluid by means of the lock fitting as a probe. Thereby, the sample drawing container (for example, open or closed) can be inserted into the lock fitting. If the lock fitting is subsequently moved axially into the retracted position, the sample drawing container (open or closed) seals the process container in a fluid-tight manner. For this purpose, the sample drawing container may also have at least one sealing element.
It is a transportable sample drawing container. Therefore, in contrast to the prior art, no further collecting vessel and/or a liquid line connected thereto are required.
The transportable sample drawing container can be inserted directly into a lock fitting. Therefore, no additional access to the process container needs to be created for sampling. This is particularly advantageous if a lock fitting is present anyway, for example since the latter is already used as an interchangeable fitting for an electrochemical sensor. The sample drawing container can be used, for example, instead of the electrochemical sensor if the latter is removed from the interchangeable fitting. As already mentioned, this is frequently the case with electrochemical sensors, for example for cleaning, maintaining, for calibrating, verifying, and/or adjusting, and/or for replacing the electrochemical sensor.

In one embodiment of the sample drawing container, the sample drawing container has two components that are mounted so as to be movable relative to one another, wherein the at least one opening can be closed and opened by a relative movement of the two components with respect to one another so that the sample drawing container is adjustable by means of the relative movement between the sample drawing position and the transport position, wherein especially at least a first of the two components is sleeve-shaped, and wherein the sample chamber is arranged in the sleeve-shaped first component.

The opening arranged at the end section is thus opened or closed by means of the relative movement. Since the end region in the retracted position of the lock fitting is in contact with the fluid, the fluid can flow into the sample chamber arranged in the interior if the sample drawing container is located in the sample drawing position.

In one embodiment of the sample drawing container, the relative movement is a rotation of the two components relative to one another, especially about an axis that is substantially parallel to the longitudinal direction of the sleeve-shaped first component, and/or the relative movement is a displacement of the two components relative to one another, especially in the longitudinal direction of the sleeve-shaped first component.

The second component is, for example, a plug-shaped component that corresponds to the first sleeve-shaped component and is designed to close the sleeve-shaped first component during the execution of the relative movement, in this case at least a displacement of the two components relative to one another, especially in the longitudinal direction of the sleeve-shaped first component. In this case, this is, for example, a dispenser in which a plug is mounted displaceably against a sleeve.

In another example, the second component is also a sleeve-shaped component. For example, the first of the two components can concentrically enclose the second component, and the first sleeve-shaped component can have at least one recess and the second sleeve-shaped component can have a recess that is congruent in each case at least in regions. The two recesses can be brought into alignment with one another in such a way that the recesses, brought into alignment with one another, of the sleeve-shaped components form the opening. In this case, it is, for example, a sample scoop, with which, for example, a rotation and/or displacement is possible for aligning the two recesses, with which the adjustment from the transport position into the sample drawing position takes place.

Of course, the second component can also be both plug-shaped and sleeve-shaped, for example a plug-shaped section and a sleeve-shaped section.

All of the aforementioned examples can of course be combined with the above-mentioned plurality of openings.

In one embodiment of the sample drawing container, a filter unit is arranged between the at least one opening and the sample chamber and is designed to filter a fluid flowing through the at least one opening, before flowing into the sample chamber.

In a development of the sample drawing container, a wall of the sample chamber is mounted displaceably, especially in the longitudinal direction of the sleeve-shaped first component, and wherein, in the sample drawing position, a fluid in contact with the first end section can flow into the sample chamber in that the volume of the sample chamber is increased by means of a displacement of the wall and the fluid is thereby drawn into the sample chamber through the at least one opening.

The displacement of the wall increases the volume of the sample chamber. In this manner, the flowing of the fluid into the sample chamber is facilitated.

The displacement of the wall can take place, for example, in that, for the sample drawing container inserted into the lock fitting in the sample drawing position, as in the case of a syringe, a drawing-up element mechanically coupled to the wall can be operated by a user. The drawing-up element is arranged, for example, on a second end section opposite the first end section in the longitudinal direction of the sleeve-shaped component, in such a way that it can also be operated by the user in the retracted position of the lock fitting. In this case, negative pressure is generated inside the sample chamber, as a result of which the fluid is drawn into the sample chamber through the opening.

Another possibility is that the wall is displaced in that a spring element mechanically coupled to the wall and initially tensioned is relaxed, wherein the volume of the sample chamber is increased when the spring element relaxes. Exactly as in the case of the above-mentioned syringe-like variant, negative pressure is thereby generated, which is compensated by the fluid flowing through the opening into the sample chamber.

A further possibility is, for example, the actuation of a magnetic switch.

In the event that the fluid in the process container itself is under pressure, a negative pressure is present inside the sample chamber relative to the process container itself, which increases the flow into the sample chamber, and is not, as mentioned above, generated by a drawing-up element, a spring element, and/or a magnetic switch.

In a particularly advantageous embodiment of the sample drawing container, a second end section, substantially opposite the first end section in the longitudinal direction of the first sleeve-shaped component, of the sample drawing container is mechanically coupled to the first end section in such a way that, by means of an operation of the second end section, the sample drawing container is adjustable between the sample drawing position and the transport position, especially by the operation causing the relative movement of the two components mounted so as to be movable relative to one another. So that the second end section can be operated, it projects out of the lock fitting, for example, in the retracted position of the sample drawing container. The mechanical coupling is, for example, a fixed connection between the second end section with the first component or the second component of the two components mounted so as to be movable relative to one another. The connection is designed in such a way that a movement, caused by the, especially manual, operation of the second end section, at the second end section moves one of the two components in such a way that the opening is closed, for example in that the plug-shaped component is pulled over the sleeve-shaped component.

With regard to the sample drawing system, the object is achieved by a sample drawing system comprising a transportable sample drawing container according to the invention and a lock fitting, wherein the sample drawing container inserted into the lock fitting is adjustable between the sample drawing position and the transport position, especially in that the sample drawing container inserted into the lock fitting can be brought at least from the sample drawing position into the transport position by means of the operation, and wherein, especially, the sample drawing container inserted into the lock fitting is adjustable from the sample drawing position into the transport position in that the second end section of the sample drawing container inserted into the lock fitting projects out of the lock fitting and can be manually operated by a user.

Thus, the sample drawing container of the sample drawing system can be inserted into the lock fitting in the sample drawing position, and the lock fitting can subsequently be moved into the retracted position so that the fluid can flow into the sample chamber. If necessary, the flowing into the sample chamber is facilitated as mentioned above by the displacement of the wall of the sample chamber. This is caused, for example, by a process pressure, increased relative to the ambient pressure, of the fluid and/or a manually operable drawing-up element and/or the relaxation of a tensioned spring element.

In an advantageous embodiment of the sample drawing system, at least one elastically deformable blocking element is arranged between the two components that are mounted so as to be movable relative to one another, and counteracts a movement of the two components mounted so as to be movable relative to one another,

and wherein the blocking element is designed in such a way
that, during the operation at the second end section for adjustment from the sample drawing position into the transport position when the relative movement is executed, the blocking element can be overcome under elastic deformation of the blocking element, and
that the blocking element blocks a return adjustment from the transport position into the sample drawing position, which is executed by the operation of the second end section.

The blocking element has the effect that, in the state in which the sample drawing container is inserted into the lock fitting, the sample drawing container can no longer be brought into the sample drawing position by means of the operation of the second end section after the adjustment from the sample drawing position into the transport position. If the operation comprises, for example, a rotational movement in a first direction, by means of which the opening is closed by means of the mechanical coupling, and the sample drawing container is brought into the transport position, a rotational movement in a direction opposite thereto does not cause the opening to be restored. In this advantageous embodiment, in the state inserted into the lock fitting, the sample drawing container can be brought one time from the sample drawing position into the transport position via the second end section.

In an advantageous development of the sample drawing system, the lock fitting is an interchangeable fitting for an electrochemical sensor, which is designed to determine and/or monitor a process variable of a fluid contained in a process container, and wherein the sample drawing container is adapted to the embodiment of the lock fitting and the embodiment of the electrochemical sensor in such a way that the sample drawing container can be inserted, instead of the electrochemical sensor, into the interchangeable fitting in an insertion position provided for the electrochemical sensor.

Here, no additional lock fitting needs to be used; rather, a lock fitting that is often used anyway and designed as an interchangeable fitting for an electrochemical sensor is advantageously used. With regard to this development, reference is made to the electrochemical sensors mentioned in the introduction.

In one embodiment of this development, the interchangeable fitting is a retraction-blocked interchangeable fitting that can be moved only in the event that an electrochemical sensor is inserted into the retraction-blocked interchangeable fitting, wherein the sample drawing system has an adapter for overcoming the retraction block of the interchangeable fitting, wherein the adapter is designed in such a way that, in the event that the adapter and the sample drawing container are inserted, instead of the electrochemical sensor, into the retraction-blocked interchangeable fitting, the interchangeable fitting can be moved.

In one embodiment, the electrochemical sensor can be screwed into the interchangeable fitting via an interchangeable fitting internal thread provided for the electrochemical sensor, the adapter has an adapter external thread and the adapter can be inserted into the interchangeable fitting in that the adapter external thread can be screwed into the interchangeable fitting internal thread for the electrochemical sensor.

Many of the interchangeable fittings known from the prior art have such a retraction block, with which the interchangeable fitting can be moved especially only when the electrochemical sensor or a probe with a corresponding external thread is inserted into an interchangeable fitting internal thread. Thus, the adapter serves to fill, with its external thread, the interchangeable fitting internal thread. By means of the adapter, the interchangeable fitting can thus also be moved axially without an electrochemical sensor inserted therein.

In one embodiment of the sample drawing system, the adapter is fixedly, especially non-releasably, connected to the sample drawing container. In this embodiment, the adapter is, for example, substantially comprised of the sample drawing container.

In an alternative embodiment of the sample drawing system, the adapter can be releasably connected to the sample drawing container, especially in that a sample drawing container external thread can be screwed into an adapter internal thread.

In this embodiment, the adapter and the sample drawing container are two separate components of the sample drawing system. This increases modularity. For example, the adapter can be designed to be reusable in a substantially unlimited manner, i.e., for several sampling operations with the same lock fitting, whereas the sample drawing container is designed only for a limited number of sampling operations, in the extreme case as a so-called single-use product.

In a particularly advantageous embodiment of the sample drawing system, the sample drawing container and the adapter are matched to one another in such a way
that, by means of a screwing movement that can be transmitted via the second end section, the sample drawing container can be screwed via the sample drawing container external thread into the adapter internal thread of the adapter inserted into the interchangeable fitting, and
that, when the same screwing movement is continued by means of a mechanical coupling between the second end section and the first end section, the sample drawing container screwed into the adapter is adjustable from the sample drawing position into the transport position, especially in the retracted position of the retraction-blocked interchangeable fitting.

Thus, the adapter internal thread provided by the adapter serves, on the one hand, to screw the sample drawing container into the interchangeable fitting with the adapter and, on the other hand, to adjust into the transport position in that the sample drawing container is initially screwed-in completely via the thread pair of sample drawing container external thread/adapter internal thread. A further execution of the same screwing movement of the sample drawing container screwed completely into the interchangeable fitting leads via the mechanical coupling to a closing of the opening. Thus, advantageously, both the screwing-in of the sample drawing container and the adjustment into the transport position are made possible by a single thread pair. Thus, the sample drawing container can be screwed in with an open opening, i.e., in the sample drawing position. After sampling, it can be brought into the transport position by further screwing. Subsequently, the sample drawing container can be unscrewed again from the adapter internal thread and thus from the interchangeable fitting, wherein a return adjustment into the sample drawing position is prevented by means of the elastically deformable blocking element.

In a development of the sample drawing system, the adapter and/or the sample drawing container have a securing element, which is designed to secure the releasable connection between the adapter and the sample drawing container,
and wherein the securing element is designed in such a way that the releasable connection between the adapter and the sample drawing container is only releasable in the case that the adapter is not inserted in the interchangeable fitting, especially is unscrewed from the interchangeable fitting.

In this development, on the one hand, the high modularity already mentioned is given, and, on the other hand, the adapter and the sample drawing container can be screwed and secured before the adapter is inserted. In the case of this additional securing, the adapter cannot remain on its own in the interchangeable fitting and lever out its retraction block. Thus, on the other hand, the high functional security of the retraction-blocked interchangeable fitting is still given.

In one embodiment of the sample drawing system, the adapter external thread is matched to the interchangeable fitting internal thread in such a way
that, by means of a screwing movement that can be transmitted via the second end section, the sample drawing container releasably or non-releasably connected to the adapter can be screwed into the interchangeable fitting internal thread via the adapter external thread, and
that, when the same screwing movement is continued by means of a mechanical coupling between the second end section and the first end section, the sample drawing container screwed into the interchangeable fitting together with the adapter is adjustable from the sample drawing position into the transport position, especially in the retracted position of the retraction-blocked interchangeable fitting.

With regard to the method, the object is achieved by a method for drawing a sample of a fluid contained in a process container with a sample drawing system according to the invention, comprising the steps of:
inserting the sample drawing container into the lock fitting;
moving the lock fitting into the retracted position, in which the first end section of the sample drawing container is brought into contact with the fluid;
drawing a sample, during which the fluid flows into the sample chamber;
adjusting the sample drawing container from the sample drawing position into the transport position;
moving the lock fitting into the extended position;
removing the sample drawing container from the lock fitting.

In one embodiment of the method, the method comprises at least the following step preceding the insertion of the sample drawing container into the lock fitting:
adjusting the sample drawing container from the transport position into the sample drawing position.

In one embodiment of the method, a retraction-blocked interchangeable fitting for an electrochemical sensor with an electrochemical sensor inserted therein is used as a lock fitting, wherein the method comprises the following steps preceding the insertion of the sample drawing container into the lock fitting:
removing the electrochemical sensor from the retraction-blocked interchangeable fitting;
attaching the adapter to the sample drawing container or inserting the adapter into the retraction-blocked interchangeable fitting after the removal of the electrochemical sensor from the interchangeable fitting.

The invention is explained further with reference to the following figures, which are not true-to-scale, wherein the same reference signs designate the same features. For reasons of clarity, or if it appears sensible for other reasons, already mentioned reference signs are not repeated in the following figures. The following are shown:

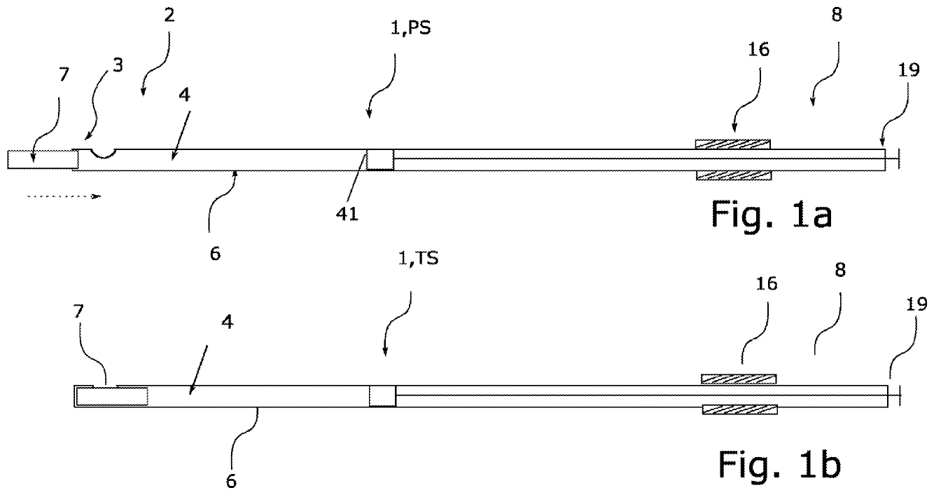

FIGS. 1 a, b: A sectional view of a first embodiment of the sample drawing container according to the invention;

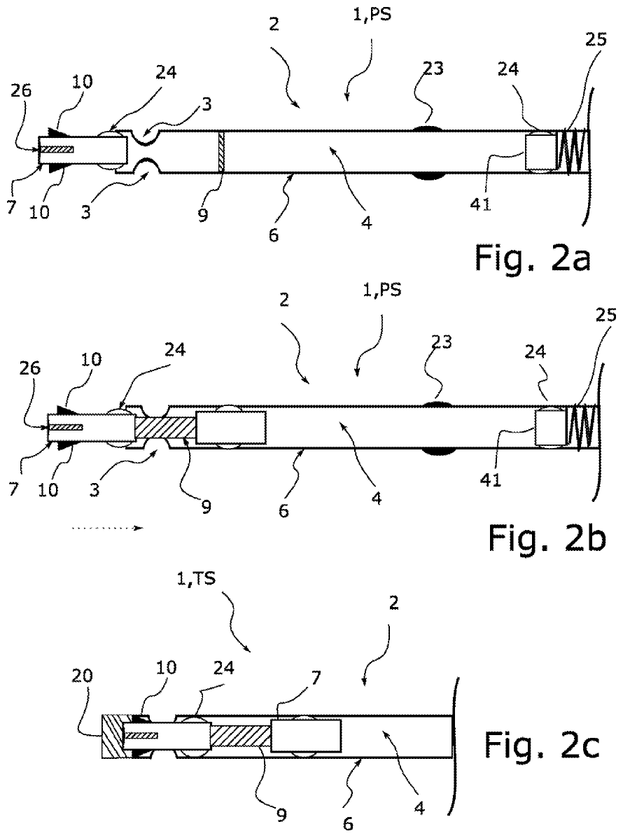

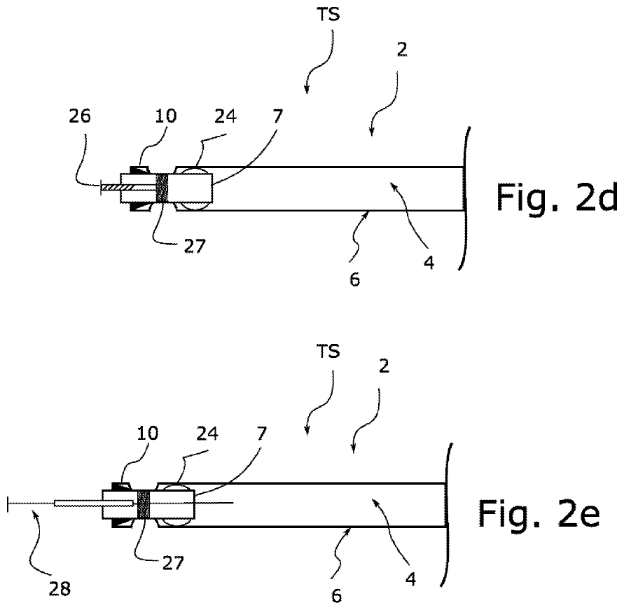

FIGS. 2 a, b, c, d, e: A sectional view of further embodiments of the sample drawing container according to the invention;

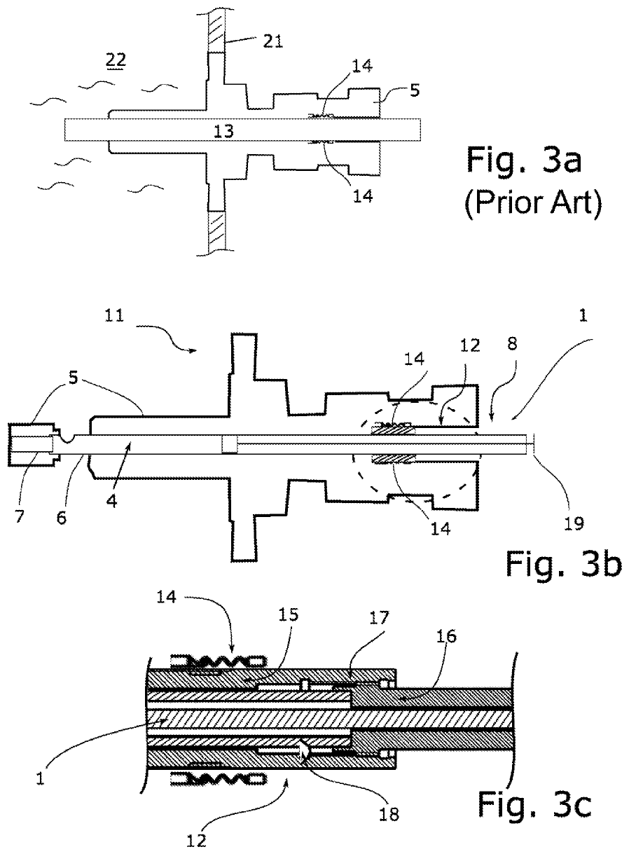

FIG. 3a: A sectional view of an example of the prior art for an interchangeable fitting with an electrochemical sensor inserted therein; and

FIGS. 3b, c: A sectional view of an embodiment of the sample drawing system according to the invention.

FIGS. 1a, b show a sectional view of an embodiment of the transportable sample drawing container 1 according to the invention: In FIG. 1a, in a sample drawing position PS, in which an opening 3 leading into a sample chamber 4 and arranged at an end section 2 is open, and in FIG. 1b, a transport position TS, in which the opening 3 is closed and the sample chamber 4 is sealed in a fluid-tight manner. The transportable sample drawing container 1 is designed as a sample drawing probe.

The sample drawing container 1 has two components 6, 7 that are mounted so as to be movable relative to one another in order to enable the adjustment between the transport position PS and the sample drawing position.

In this embodiment, the first of the two components 6 is designed as a sleeve-shaped cylinder, in which a sample chamber 4 is arranged. Due to its high chemical resistance, glass, for example, is suitable as a material for the sleeve-shaped cylinder with the sample chamber for a variety of different fluids. In this embodiment, the second of the two components 7 is designed as a plug closing the sleeve-shaped cylinder 6. The plug-shaped component 6 can also comprise sleeve-shaped sections, see for example FIGS. 2b, c. An opening 3 is introduced into the sleeve-shaped first component 6. Of course, a plurality of openings 3, i.e., at least two openings 3, which are, for example, arranged on opposite sides of the first component, can also be introduced (see FIGS. 2 a-c). By means of the at least one opening 3, a fluid 22 surrounding the first end section 2 (see FIG. 3a) can flow into the sample chamber 4 in the sample drawing position PS (FIG. 1a).

The sample chamber 4 also has a displaceably mounted wall 41, by means of which the volume of the sample chamber 4 can be increased. For this purpose, the sample drawing container 1 has, on a second end section 8, which is opposite the first end section 2 in the longitudinal direction of the sleeve-shaped first component 6, a drawing-up element 19 that, as in the case of a syringe, is mechanically coupled to the wall 41 of the sample chamber 4 and can be operated by a user in the state inserted into the lock fitting 5 (see FIG. 3b). As a result, negative pressure can be generated, for example, by means of which the flowing of the fluid 22 into the sample chamber 4 is intensified when such negative pressure is compensated. In the event that the fluid 22 is at a process pressure that is increased relative to the ambient pressure, the sample chamber 4 can optionally be depressurized by means of the drawing-up element 19.

In order to shift the sample drawing container after the sampling from the sample drawing position PS into the transport position TS in this embodiment, the second component 7 is displaced in the longitudinal direction of the sleeve-shaped first component 6 (see dashed arrow). Thereby, the opening 3 is closed in that the plug-shaped second component 7 moves into the sleeve-shaped first component 6, as a result of which the opening 3 is closed and the sample chamber 4 is sealed in a fluid-tight manner.

As already mentioned above, the special embodiment shown here of the two components 6, 7 of the sample drawing container 1, which components are mounted so as to be movable relative to one another, is only one of many possible variants to which the invention is, of course, not limited.

The sample drawing container 1 can be inserted into a lock fitting 5 (not shown here, see FIG. 3). For this purpose, the sample drawing container 1 in this embodiment has a sample drawing container external thread 16, by means of which it can be screwed into a lock fitting 5. If the sample drawing container 1 is screwed into the fitting 5 in the sample drawing position PS, the screwing movement can be carried out further after the sampling, without the sample drawing container 1 as a whole thereby being moved further in an axial movement in the direction of the fluid 22, for example in that the sample drawing container 1 abuts against a block element of the interchangeable fitting (see FIG. 3b) (the sample drawing container 1 is then, so to speak, screwed until contact). The second component 7 is mechanically coupled to the end section 8 in such a way that, when the screwing movement is carried out further, the second component 7 is retracted in the direction of the first component 6. As a result, the relative movement of the two components 6, 7 is triggered for closing the opening 3, and the sample drawing container 1 is brought into the transport position TS.

Further details of the first end section 2 are shown in a sectional view in a further embodiment of the sample drawing container 1 according to the invention in FIGS. 2a to 2e, wherein FIGS. 2a and 2b show embodiments of the sample drawing container in the sample drawing position PS and in FIGS. 2c to 2e in the transport position TS. Unlike the variant already shown in FIG. 1, the sample drawing container 1 here has two openings 3. In addition or as an alternative to the syringe variant shown in FIG. 1, a spring element 25 mechanically coupled to the wall 41 of the sample chamber 4 is provided here (see FIGS. 2a, 2b). When the spring element 25 is tensioned, the wall 41 is displaced in the direction of the first end section 2. If the sample drawing container 1 with a tensioned spring element 25 is brought into contact with the fluid, a subsequent relaxation of the spring element 25 therefore leads to a displacement of the wall 41 in the direction of the second end section 8 and thus to an increase in the volume of the sample chamber 4 and to the negative pressure already mentioned above. A variant that is not shown in greater detail here, comprising a magnetic switch, with which the displaceable wall 41 of the sample chamber 4 is moved in order to increase the volume of the sample chamber 4, functions in a similar manner.

For fluid-tight sealing, the sample drawing container 1 may also have sealing elements 23 and/or 24. In this case, the sealing elements 23 arranged here on an external wall of the sample drawing container 1 serve the purpose of the sample drawing container in the state inserted into the lock fitting 5 sealing the process container 21 (see FIG. 3a) in a fluid-tight manner in the retracted state of the locking fitting 5. In addition, sealing elements 24 are also arranged between the two components 6, 7 and close the sample chamber 4 in a fluid-tight manner, for example in the transport position TP of the sample drawing container 1, i.e., when the openings 3 are closed.

Optionally, the sample drawing container 1 also has an elastically deformable blocking element 10, which counteracts a movement of the two components 6, 7. The blocking element 10 is designed in such a way that, when operating at the second end section 8 for adjustment from the sample drawing position PS into the transport position TS, the blocking element 10 can be overcome with elastic deformation, in this case here the further screwing movement with which the second component 7 is retracted in the direction of the first component 6 (see transition from FIGS. 2b to 2c). In contrast, the blocking element 10 blocks a return adjustment from the transport position TS into the sample drawing position PS, which is executed by operating the second end section 8. For this purpose, the blocking element 10 has, for example, the triangular profile shown here. This ensures that, when the sample drawing container 1 is unscrewed from the lock fitting 5, the opening 3 is not opened again and the sample drawing container 1 remains in the transport position TS. The material of the blocking element comprises, for example, an elastomer.

In FIGS. 2a, b, a filter unit 9 is also shown. The latter is arranged in an embodiment of the sample drawing container between the opening 3 and the sample chamber 4 and is designed to filter the sample after flowing through the opening(s) and before flowing into the sample chamber 4. The filter unit 9 is optionally replaceable.

In the embodiment shown in FIGS. 2b, 2c, the filter unit 9 is designed as a filter tube that is comprised by the second component 7 and/or is connected thereto. For this purpose, for example, as shown in FIGS. 2b, c, the filter tube can be inserted between two sections of the second component 7. During the sample drawing, the fluid flows over a wall of the filter tube into the filter tube and is subsequently guided through it into the sample chamber 4. An advantage of the embodiment of the filter unit 9 as a filter tube is that, in the filter tube shown in FIGS. 2b, 2c, the effective filter surface is substantially increased in comparison to the filter unit 9 shown in FIG. 2a. An additional advantage of the filter tube connected to or comprised by the second component 7 is that the filter unit 9 can be removed particularly easily from the first component 6 since the second component 7 is designed, for example, to be releasable from the first component 6. The simple removal facilitates cleaning of the filter unit 9 and/or analysis of substances and/or particles received in the filter unit 9. A replacement of the filter unit 9 required from time to time is also particularly easy to perform. In order to protect the transportable sample drawing container 1 during transport, it can also have a closure 20, for example in the form of a closure cap, for the first end section 2, see FIG. 2c.

In one embodiment, the second component 7 or at least a section of the second component 7 can be removed, especially unscrewed, in order to remove the sample from the portable sample drawing container 1 after the transport thereof. For this purpose, the second component 7 has, for example, a securing element 26, for example a screw. Thus, the sample can be subjected to further treatment and/or analysis, for example in a special laboratory. The great advantage of the very compact and transportable solution is shown here since, in this way, the sample can also be examined in a location arranged far away from the fluid 22. In the same manner, the sample drawing container 1 outside the lock fitting 5 can be returned from the transport position TS into the sample drawing position PS.

FIGS. 2d, e show further embodiments, which represent alternative possibilities for removing the sample of the fluid 22 from the sample drawing container 1 after the sampling (i.e., outside the lock fitting 5). Unlike previously described, the removal of the sample from the sample chamber 4 is carried out in FIGS. 2d, e in the transport position TS, i.e., with opening(s) 3 always closed. For this purpose, in FIGS. 2d, e, the second component 7 comprises a blocked fluid-tight access 27 to the sample chamber 4. The fluid-tight access 27 is, for example, inserted into the threaded channel of the screw 26 already shown in FIGS. 2a to 2c.

The access 27 is designed, for example, as a fluid-tight valve unit that is arranged in the threaded channel of the screw 26. In the case of the valve unit, this is therefore a blockable and openable access 27. Through the open thread of the screw 26, the access 27 designed as a valve unit can be opened with a rotary mechanism and the sample can be removed from the sample chamber 4.

In the embodiment shown in FIG. 2e, the access 27 is designed as a substantially fluid-impermeable membrane, for example a so-called septum. This variant is especially suitable for gaseous fluids since otherwise, when an opening is present, the gas may, depending on the type of gas, escape uncontrollably from the sample chamber 4. Here, a “substantially gas-impermeable membrane” means that the diffusion rate of the membrane for the gaseous fluid is sufficiently small so that the gaseous fluid cannot diffuse out of the sample chamber 4 in the usual time scales of the sampling (for example, in one day, at most 10% of the amount of the gas contained in the sample chamber 4). A syringe is pierced through the membrane in order to therewith remove the gaseous fluid from the sample chamber 4 for further treatment and/or analysis, without damaging the membrane in the process. Due to the possibility of introducing the syringe, the membrane (exactly as previously the valve unit) forms a reclosable access 27.

FIGS. 3b, 3c show a sectional view of an embodiment of the sample drawing system 11 according to the invention, comprising a lock fitting 5 and a transportable sample drawing container 1.

FIG. 3a shows a lock fitting which is known from the prior art and designed as an interchangeable fitting, axially movable manually or (semi)automatically, for example by means of a pneumatic system, for a probe-shaped electrochemical sensor 13. The lock fitting 5 is inserted into a wall of a process container 21. The electrochemical sensor 13 can be moved by means of the lock fitting 5 in such a way that with a sensitive component arranged at its end section, it is in direct contact with a fluid 22 surrounding the end section. The electrochemical sensor 13 is typically screwed into the lock fitting 5 via an interchangeable fitting internal thread 14.

In FIG. 3b, the transportable sample drawing container 1 already described in the previous embodiments is now inserted into the lock fitting 5 from FIG. 3a. In this case, the electrochemical sensor 13 is removed (for example, within the framework of the cleaning, calibration, verification and/or adjustment of the electrochemical sensor 13) and the sample drawing container 1 is inserted, instead of the electrochemical sensor 13, into the insertion position provided for the electrochemical sensor 13 in the lock fitting 5.

In the embodiment shown here, the sample drawing container 1 is inserted into the lock fitting 5 in the sample drawing position PS, and the lock fitting 5 is subsequently moved into the retracted position. In the retracted position, the first end section 2 of the sample drawing container 1 projects into the fluid 22 in such a way that the latter can flow into the sample chamber 4 in the sample drawing position PS, i.e., when the opening is open (see FIGS. 1a and 2a).

By means of a drawing-up element 19, in the syringe-like variant of the sample drawing container 1 shown here, the flowing of the fluid 22 into the sample chamber 4 can be intensified. The drawing-up element is located on the second end section 8 opposite the first end section 2 in the longitudinal direction of the probe-shaped sample drawing container 1. Said second end section also projects out of the lock fitting 5 in the retracted position of the lock fitting 5 and therefore can be operated by a user.

After sampling, the adjustment from the sample drawing position PS into the transport position TS also takes place by means of the operation of the second end section 8 projecting from the lock fitting 5 in the retracted position. Thereby, the relative movement for closing the opening 3 via a corresponding manipulation of the second end section 8 can be triggered by means of a mechanical coupling between the end section 8 and one of the two movably mounted components 6, 7 (for example, a fixed mechanical connection). In the embodiment shown here, the adjustment from the sample drawing position PS into the transport position TS is achieved by the second component 7 abutting against a section of the interchangeable fitting 5 when the sample drawing container 1 is further inserted into the interchangeable fitting 5 and thereby being displaced back in the direction of the first component 7 (see direction of the dashed arrows in FIGS. 1a and 2b).

Often, retraction-blocked lock fittings 5 are used. They can only be moved in the event that the electrochemical sensor 13, or alternatively a probe matching the interchangeable fitting internal thread 14, i.e., with an external thread corresponding thereto, is screwed into the interchangeable fitting internal thread 14 provided for the electrochemical sensor 13.

In order to overcome the retraction block, an adapter 12 is used, which is comprised by the sample drawing system 11 and is matched to the lock fitting 5 or the matching electrochemical sensor 13. In FIG. 3b, the adapter 12 is arranged in the region indicated by the dashed line and shown again in detail in FIG. 3c. The adapter 12 is screwed with an adapter external thread 15 into the interchangeable fitting internal thread 14. In this embodiment, the adapter 12 is releasably connected to the sample drawing container 1 via a screw connection in that a sample drawing container external thread 16 can be screwed into an adapter internal thread 17. As mentioned above, the adapter 12 can also be fixedly connected to the sample drawing container 1.

Depending on the embodiment, after the removal of the electrochemical sensor 13 from the interchangeable fitting, either the sample drawing container 1 is screwed into the adapter 12 already screwed into the lock fitting 5, or the sample drawing container 1 and adapter 12 are jointly screwed into the lock fitting 5 as one unit connected to one another (releasably or non-releasably). In the latter case, in the case of the releasable unit, the sample drawing container 1 and adapter 12 are, for example, already screwed to one another outside the lock fitting 5 and are then screwed as one screwed unit into the interchangeable fitting internal thread 14. It is advantageous if the relative movement for closing the opening 3 is triggered by further executing the screw-in movement by means of which the sample drawing container 1 is screwed into the lock fitting 5.

Optionally, an additional securing means 18 is provided, with which the releasable connection between the sample drawing container 1 and the adapter 12 is secured. This prevents the sample drawing container 1 from being unscrewed from the adapter 12 in the retracted position of the lock fitting 5.

### REFERENCES SIGNS AND SYMBOLS

1 Sample drawing container

2 First end section

3 Opening

4 Sample chamber

41 Wall of the sample chamber

5 Lock fitting

6,7 First and second components

8 Second end section

9 Filter unit

10 Blocking element

11 Sample drawing system

12 Adapter

13 Electrochemical sensor

14 Interchangeable fitting internal thread

15 Adapter external thread

16 Sample drawing container external thread

17 Adapter internal thread

18 Securing element

19 Drawing-up element

20 Closure element

21 Process container

22 Fluid

23, 24 Sealing element

25 Spring element

26 Securing element

27 Access

28 Syringe

PS Sample drawing position

TS Transport position

1-19. (canceled)

20. A transportable sample drawing container for drawing a sample of a fluid contained in a process container,
wherein the sample drawing container is adjustable between a sample drawing position and a transport position,
wherein at least one closable opening which is arranged on a first end section of the sample drawing container and which leads into an interior of the sample drawing container is open in the sample drawing position,
wherein, in the transport position, a sample chamber which is arranged in the interior is sealed in a fluid-tight manner,
and wherein the sample drawing container can be inserted into a movable lock fitting connected to the process container in such a way
that, in a first extended position of the lock fitting, the lock fitting seals the process container in a fluid-tight manner and
that, in a second retracted position of the lock fitting, the sample drawing container seals the process container in a fluid-tight manner and the sample drawing container inserted into the lock fitting projects with its first end section into the fluid.

21. The sample drawing container according to claim 20,
wherein the sample drawing container has two components that are mounted so as to be movable relative to one another,
wherein the at least one opening can be closed and opened by a relative movement of the two components with respect to one another so that the sample drawing container is adjustable between the sample drawing position and the transport position by means of the relative movement,
wherein at least a first of the two components is sleeve-shaped,
and the sample chamber is arranged in the sleeve-shaped first component.

22. The sample drawing container according to claim 21,
wherein the relative movement is a rotation of the two components relative to one another about an axis that is substantially parallel to the longitudinal direction of the sleeve-shaped first component,
and/or wherein the relative movement is a displacement of the two components relative to one another in the longitudinal direction of the sleeve-shaped first component.

23. The sample drawing container according to claim 21,
wherein a filter unit is arranged between the at least one opening and the sample chamber and is designed to filter a fluid flowing through the at least one opening, before flowing into the sample chamber.

24. The sample drawing according to claim 21,
wherein a wall of the sample chamber is mounted displaceably in the longitudinal direction of the sleeve-shaped first component,
and wherein, in the sample drawing position, a fluid in contact with the first end section can flow into the sample chamber in that the volume of the sample chamber is increased by means of a displacement of the wall and the fluid is thereby drawn into the sample chamber through the at least one opening.

25. The sample drawing container according to claim 21,
wherein a second end section, opposite the first end section in the longitudinal direction of the first sleeve-shaped component, of the sample drawing container is mechanically coupled to the first end section in such a way that, by operation of the second end section, the sample drawing container is adjustable between the sample drawing position and the transport position by the operation causing the relative movement of the two components that are mounted so as to be movable relative to one another.

26. A sample drawing system comprising a sample drawing container according to claim 20 and a lock fitting,
wherein the sample drawing container inserted into the lock fitting is adjustable between the sample drawing position and the transport position in that the sample drawing container inserted into the lock fitting can be brought at least from the sample drawing position into the transport position by the operation,
and wherein the sample drawing container inserted into the lock fitting is adjustable from the sample drawing position into the transport position in that the second end section of the sample drawing container inserted into the lock fitting projects out of the lock fitting and can manually be operated by a user.

27. The sample drawing system according to claim 26,
wherein at least one elastically deformable blocking element is arranged between the two components that are mounted so as to be movable relative to one another and counteracts a movement of the two components,
and wherein the blocking element is designed in such a way
that, during the operation of the second end section for adjustment from the sample drawing position into the transport position when the relative movement is executed, the blocking element can be overcome under elastic deformation of the blocking element, and
that the blocking element blocks a return adjustment from the transport position into the sample drawing position, which is executed by the operation of the second end section.

28. The sample drawing system according to claim 26,
wherein the lock fitting is an interchangeable fitting for an electrochemical sensor, which is designed to determine and/or monitor a process variable of a fluid contained in a process container, and wherein the sample drawing container is adapted to the embodiment of the lock fitting and the embodiment of the electrochemical sensor in such a way that the sample drawing container can be inserted, instead of the electrochemical sensor, into the interchangeable fitting in an insertion position provided for the electrochemical sensor.

29. The sample drawing system according to claim 26,
wherein the interchangeable fitting is a retraction-blocked interchangeable fitting that can be moved only in the event that an electrochemical sensor is inserted into the retraction-blocked interchangeable fitting,
and wherein the sample drawing system has an adapter for overcoming the retraction block of the interchangeable fitting,
wherein the adapter is designed in such a way that, in the event that the adapter and the sample drawing container are inserted, instead of the electrochemical sensor, into the retraction-blocked interchangeable fitting, the interchangeable fitting can be moved.

30. The sample drawing system according to claim 29,
wherein the electrochemical sensor can be screwed into the interchangeable fitting via an interchangeable fitting internal thread provided for the electrochemical sensor, the adapter has an adapter external thread,
and the adapter can be inserted into the interchangeable fitting in that the adapter external thread can be screwed into the interchangeable fitting internal thread for the electrochemical sensor.

31. The sample drawing system according to claim 26,
wherein the adapter is fixedly non-releasably, connected to the sample drawing container.

32. The sample drawing system according to claim 26,
wherein the adapter can be releasably connected to the sample drawing container in that a sample drawing container external thread can be screwed into an adapter internal thread.

33. The sample drawing system according to claim 32,
wherein the sample drawing container and the adapter are matched to one another in such a way
that a screwing movement that can be transmitted via the second end section, the sample drawing container can be screwed via the sample drawing container external thread into the adapter internal thread of the adapter inserted into the interchangeable fitting, and
that, when the same screwing movement is continued by means of a mechanical coupling between the second end section and the first end section, the sample drawing container screwed into the adapter can be adjusted from the sample drawing position into the transport position.

34. The sample drawing system according to claim 32,
wherein the adapter and/or the sample drawing container have a securing element, which is designed to secure the releasable connection between the adapter and the sample drawing container,
and wherein the securing element is designed in such a way that the releasable connection between the adapter and the sample drawing container is only releasable in the case that the adapter is not inserted in the interchangeable fitting.

35. The sample drawing system according to claim 31,
wherein the adapter external thread is matched to the interchangeable fitting internal thread in such a way
that, by means of a screwing movement that can be transmitted via the second end section, the sample drawing container releasably or non-releasably connected to the adapter can be screwed into the interchangeable fitting internal thread via the adapter external thread, and
that, when the same screwing movement is continued by means of a mechanical coupling between the second end section and the first end section, the sample drawing container screwed together with the adapter into the interchangeable fitting can be adjusted from the sample drawing position into the transport position.

36. A method for drawing a sample of a fluid contained in a process container with a sample drawing system according to claim 27, comprising the steps of:
inserting the sample drawing container into the lock fitting;
moving the lock fitting into the retracted position, in which the first end section of the sample drawing container is brought into contact with the fluid;
drawing a sample, during which the fluid flows into the sample chamber;
adjusting the sample drawing container from the sample drawing position into the transport position;
moving the lock fitting into the extended position;
removing the sample drawing container from the lock fitting.

37. The method according to claim 36,
wherein the method comprises at least the following step preceding the insertion of the sample drawing container into the lock fitting:
adjusting the sample drawing container from the transport position into the sample drawing position.

38. The method according to claim 36,
wherein a retraction-blocked interchangeable fitting for an electrochemical sensor with an electrochemical sensor inserted therein is used as the lock fitting,
and wherein the method comprises the following steps preceding the insertion of the sample drawing container into the lock fitting:
removing the electrochemical sensor from the retraction-blocked interchangeable fitting;
attaching the adapter to the sample drawing container or inserting the adapter into the retraction-blocked interchangeable fitting after removing the electrochemical sensor from the interchangeable fitting.
